(19) United States
(12) Patent Application Publication
(10) Pub. No.: US 2006/0224757 A1
(43) Pub. Date: Oct. 5, 2006

(54) System and method for streaming service replication a in peer-to-peer network

(76) Inventors: Han Fang, Beijing (CN); Xiangyang Chen, Beijing (CN); Xin Yu, Beijing (CN)

Correspondence Address: HAYNES AND BOONE, LLP, 901 MAIN STREET, SUITE 3100, DALLAS, TX, 75202, US

(21) Appl. No.: 11/154,452

(22) Filed: Jun. 16, 2005

Related U.S. Application Data
(60) Provisional application No. 60/662,131, filed on Mar. 15, 2005.

(51) Int. Cl. G06F 15/16

(52) U.S. Cl. 709/231

(57) ABSTRACT

A method, computer-readable medium and data processing system for replicating streaming content in a peer-to-peer network is provided. A first client of the peer-to-peer network receives streaming content encapsulated in one or more data blocks formatted according to a transport format of the peer-to-peer network. The first client extracts the streaming content from the one or more data blocks and assembles the streaming content into a native format of the streaming content. The streaming content is stored in the native format. The first client conveys at least a portion of the streaming content in the native format to a second client external to the peer-to-peer network.

### RELATED APPLICATION DATA

This patent application claims the benefit of provisional U.S. patent application Ser. No. 60/662,131, filed Mar. 15, 2005.

Additionally, this application is also related to commonly assigned U.S. patent application No.______ , filed concurrently herewith, Attorney Docket No. 33189.6, entitled “SYSTEM AND METHOD FOR ERROR RECOVERY FOR MASSIVE EXIT IN PEER-TO-PEER NETWORK,” which is incorporated herein by reference.

### BACKGROUND

In a client-server network adapted to provide streaming multimedia services such as streaming video or audio, many clients may participate in a video streaming session. The processing capacity of a media server in such a network is limited. If the number of clients connected to the media server exceeds the processing or transmission capacity of the server, the media server may be unable to provide a high quality of service to the clients, crash, discontinue service to clients, or refuse service or connection to clients.

Service problems associated with excessive loads placed on a streaming source in a client-server network have conventionally been addressed by deploying multiple servers in the client-server network. For example, multiple servers may be deployed in a cluster mode such that connecting clients are unaware of the multiple servers providing the streaming content. However, cluster mode server configurations can only provide improved streaming service quality from a processing performance standpoint. Problematically, streaming service deficiencies related to transmission capacity are not addressed by cluster mode solutions in a client-server network.

### BRIEF DESCRIPTION OF THE DRAWINGS

Aspects of the present disclosure are best understood from the following detailed description when read with the accompanying figures, in which:

FIG. 1 is a diagrammatic representation of an embodiment of a client-server network that may provide streaming services to various clients;

FIG. 2 is a diagrammatic representation of an embodiment of a peer-to-peer network that may feature streaming service replication;

FIG. 3 is a diagrammatic representation of an embodiment of a streaming content data unit encapsulated in a peer-to-peer transport packet that may be distributed within a peer-to-peer network;

FIG. 4 is a diagrammatic representation of an embodiment of a peer-to-peer network with peer clients configured as replicated streaming sources that provide replicated content of a streaming source;

FIG. 5 is a diagrammatic representation of an embodiment of a software configuration that facilitates distribution of streaming content in a peer-to-peer network;

FIG. 6 is a diagrammatic representation of an embodiment of a software configuration that facilitates streaming content replication in a peer-to-peer network;

FIG. 7 is a flowchart of an embodiment of processing performed by a peer client for configuration of the peer client as a replicated streaming source in a peer-to-peer network; and

FIG. 8 is a flowchart of an embodiment of processing performed by a control server in a peer-to-peer network for facilitating delivery of streaming content in a peer-to-peer network.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

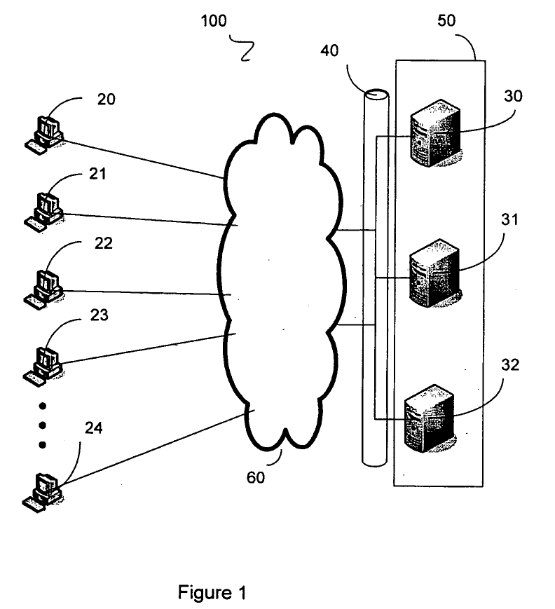

FIG. 1 is a diagrammatic representation of an embodiment of a client-server network 100 that may provide streaming services to various clients 20-24. Client-server network 100 comprises multiple content servers 30-32 configured in a cluster 50. Content servers 30-32 may store or otherwise access duplicate streaming content. For example, content servers 30-32 may access and stream content in a RealAudio, RealVideo, advanced streaming format (ASF), or another streaming media format. Content servers 30-32 may be interconnected by a network link 40, such as an Ethernet. Streaming services provided by cluster 50 may be load-balanced among content servers 30-32. Clients 20-24 are provided streaming services by connecting with cluster 50, for example by way of a public network 60, such as the Internet.

Each of content servers 30-32 may provide streaming service processing for a finite number of clients, and thus the client service capacity of cluster 50 is limited to the aggregate service capacity of content servers 30-32. If the demand placed on cluster 50 becomes too large, the streaming service quality provided to clients 20-24 may be degraded or one or more of clients 20-24 may be disconnected from cluster 50. Conventional solutions for addressing excessive loads placed on cluster 50 generally include expanding the processing capacity of cluster 50, for example by adding additional content servers to cluster 50, upgrading the capacity of existing content servers, or by other mechanisms. Such system reconfigurations are costly due to both hardware and labor expenses.

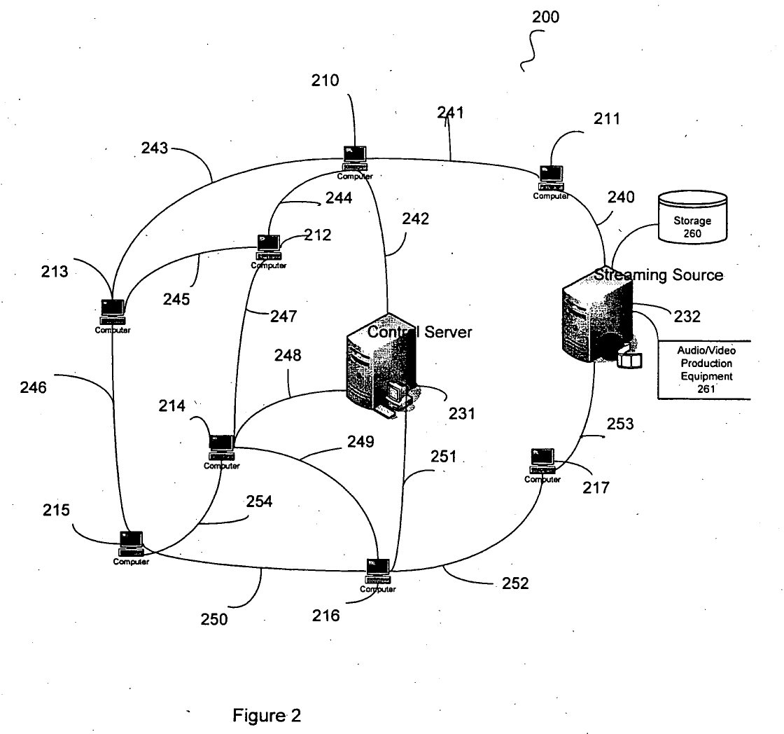

FIG. 2 is a diagrammatic representation of an embodiment of a peer-to-peer network 200 that may feature streaming service replication. Network 200 includes various peer clients 210-217 that may be interconnected with other clients in network 200. Additionally, network 200 may include a control server 231 and a streaming source 232. Streaming source 232 may be implemented as a single streaming content server or may be implemented as a streaming content cluster, such as cluster 50 shown in FIG. 1. One or more clients may connect with control server 231 and streaming source 232 in addition to other network clients. Clients 210-217 may connect with other network clients, control server 231, and streaming source 232 by network connections 240-254, such as wire, wireless communication links, fiber optic cables, or other suitable network media. Control server 231 may organize clients 210-217 that have joined network 200. Clients 210-217 may be implemented as data processing systems, such as personal computers, wired or wireless laptop computers, personal digital assistants, or other computational devices capable of network communications.

Streaming source 232 may be implemented as a server that stores or accesses streaming content, such as video, audio, or the like, and streams the data to one or more clients in network 200. For example, the streaming content may be retrieved from a file that is accessed by streaming source 232 from a storage device 260. Alternatively, the streaming content may be produced from, for example, audio/video production equipment 261 that is provided to streaming source 232. The streaming content comprises data encoded in a native streaming format, such as RealAudio formatted files, RealVideo formatted files, ASF, or another streaming format that may be processed by a streaming media application, such as RealPlayer, Windows Media Player, or another streaming media application.

Network 200 may comprise a transient Internet network, and thus clients 210-217, control server 231, and streaming source 232 may use the Transmission Control Protocol/Internet Protocol (TCP/IP) suite of protocols to communicate with one another. Alternatively, network 200 may be implemented in any number of different types of networks, such as for example, an intranet, a local area network (LAN), or a wide area network (WAN). FIG. 2 is intended as an example, and not as an architectural limitation of embodiments described herein.

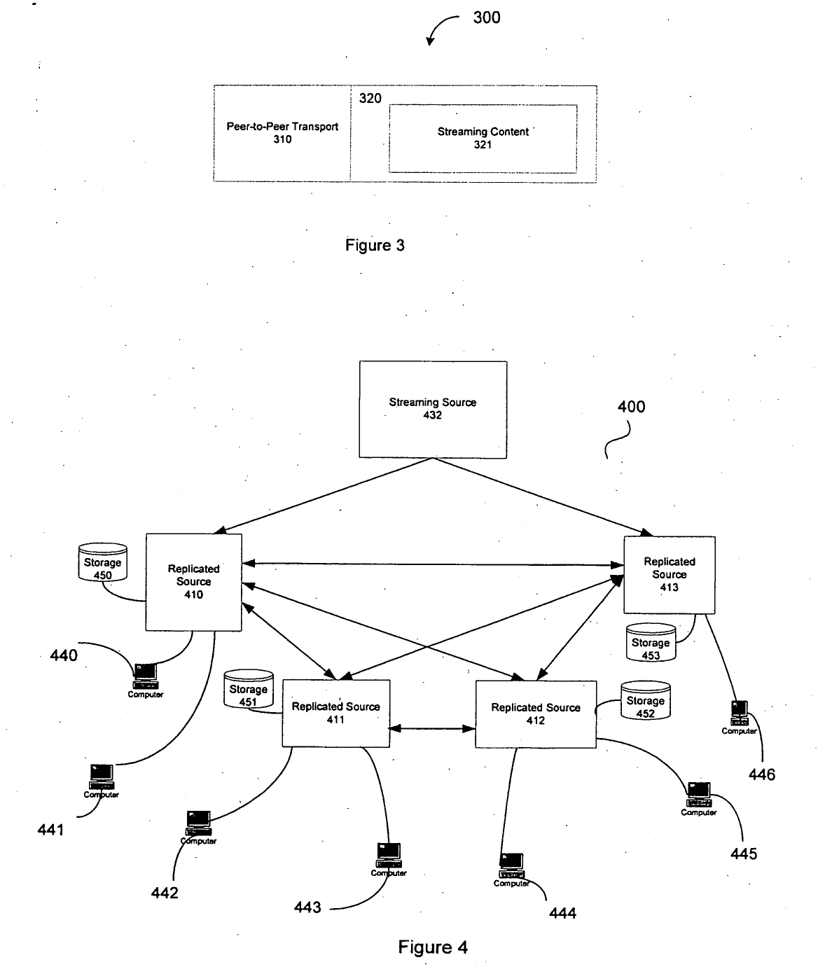

FIG. 3 is a diagrammatic representation of an embodiment of a streaming content data unit 321 encapsulated in a peer-to-peer transport packet 300, or data block, that may be distributed within peer-to-peer network 200. Peer-to-peer transport packet 300 may include a transport header 310 or other field that may contain parameters that facilitate delivery and processing of data in peer-to-peer network 200. Peer-to-peer transport packet 300 may include a payload field 320 in which streaming content data unit 321 may be inserted. Streaming source 232 obtains streaming data, for example from storage device 260, audio/video production equipment 261, or the like, segments the streaming data into one or more streaming content data units, and inserts a streaming content data unit 321 into payload field 320. Payload field 320 may be of a fixed or dynamic length. Accordingly, streaming source 232 may generate a sequence of transport packets 300 that each include a respective streaming content segment or data unit that each respectively comprises streaming data segmented from a streaming data source, such as a streaming source file or streaming source produced by audio/video production equipment 261. The streaming content inserted into payload field 320 is preferably encapsulated within transport packet 300 in a native streaming content format, e.g. ASF, RealAudio, RealVideo, or the like. Thus, peer-to-peer transport packet 300 provides a mechanism for distribution of streaming content within peer-to-peer network 200.

Returning again to FIG. 2, control server 231 maintains a peer list that includes connectivity information, such as a network address and port number, of respective peer clients that are connected within peer-to-peer network 200. When control server 231 generates the peer list, connectivity information of streaming source 232 may be the only connectivity information included in the peer list. A client joins peer-to-peer network 200 by first connecting with control server 231 and submitting a request for the peer list that contains connectivity information of peer clients within peer-to-peer network 200 with which the requesting client may connect. The control server returns the peer list to the requesting client, and the client joins network 200 by selecting one or more nodes having connecting information included in the peer list and connecting with the selected nodes. When a new client joins peer-to-peer network 200, control server 232 may add connectivity information of the newly joining client to the peer list. In this manner, as additional clients join the peer-to-peer network, the availability of peer clients with which subsequently joining clients may connect is increased. Connectivity information of streaming source 232 may be removed from the peer list, for example when the number of clients connected within peer-to-peer network 200 reaches a pre-defined threshold. In this manner, the streaming session load placed on streaming source 232 may be reduced. A client connected within peer-to-peer network 200 that desires streaming content originally provided by streaming source 232 may submit a query for the streaming content to peer clients with which the requesting client is connected. If no peer clients within network 200 have the requested streaming content (or no peer clients within network 200 are available for delivery of the streaming content to the requesting client), the requesting client may obtain the streaming content from streaming source 232. A peer client may receive streaming content in the peer-to-peer transport format described above with reference to FIG. 3 from streaming source 232 or another peer client as described more fully below.

In accordance with embodiments described herein, a peer client that receives streaming content from streaming source 232 may be configured to distribute the streaming content to other peer clients, for example on receipt of a request for the streaming content from a peer client, in the peer-to-peer transport format. Additionally, a peer client that has received the streaming content may be configured to distribute the streaming content to nodes external to the peer-to-peer network in the native streaming content format. A peer client configured for distribution of streaming content in the native format of the streaming content to a client external to the peer-to-peer network is referred to herein as a replicated streaming source (or simply a replicated source). In this manner, the streaming content may be dynamically replicated within peer-to-peer network 200 in a manner that reduces or eliminates the load placed on streaming source 232.

As described above, streaming source 232 distributes streaming content to peer clients by first encapsulating the streaming content into a peer-to-peer transport format and transmitting the encapsulated streaming content to peer clients. In accordance with embodiments described herein, a client receiving streaming content in the peer-to-peer transport format from streaming source 232 may function as a replicated streaming source by reconstructing the encapsulated streaming content received from streaming source 232 into the native streaming format.

FIG. 4 is a diagrammatic representation of an embodiment of a peer-to-peer network 400 with peer clients configured as replicated streaming sources 410-413 that provide replicated content of a streaming source 432. Replicated streaming sources 410-413 are each examples of a respective peer-to-peer client, such as one of peer-to-peer clients 210-217 shown in FIG. 2. Clients 440-446 are external to peer-to-peer network 400 and may comprise, for example, IP clients. In accordance with embodiments described herein, clients 440-446 are not required to have peer-to-peer networking capabilities.

Streaming content is downloaded from streaming source 432 by one or more of replicated streaming sources 410-413. For example, replicated streaming source 410 may connect with streaming source 432 and download streaming content encapsulated according to the peer-to-peer transport format described above in FIG. 3. On receipt of streaming content from streaming source 432, replicated streaming source 410 may store the received streaming content in the peer-to-peer transport format for later distribution to other peer clients. For example, replicated streaming source 410 may store the received streaming content in a local storage device 450, such as a memory or file cache. Other peer clients may then obtain the encapsulated streaming content from replicated streaming source 410. In a similar manner, replicated streaming sources 411-413 may obtain streaming content (or a portion thereof) from streaming source 432 or other replicated streaming sources that maintain the streaming content and store the received streaming content in a respective storage device 451-453. Thus, peer-to-peer network clients may obtain streaming content made available by a streaming source, store the streaming content, and convey the stored streaming content to other peer clients. In this manner, the load placed on a streaming source in peer-to-peer network 400 may be reduced or eliminated by distributing the demand for the streaming content to the replicated streaming sources.

The streaming content received and stored by replicated streaming sources 410-413 may comprise common or different portions of the streaming content maintained and distributed by streaming source 432. In addition to facilitating distribution of streaming content within peer-to-peer network 400, replicated streaming sources 411-413 may reconstruct saved streaming content into the native streaming format for delivery to clients external to peer-to-peer network 400. For example, a replicated streaming source may extract streaming content data unit 321 from saved peer-to-peer formatted data packets 300., The extracted streaming content may then be streamed to clients 440-446 that are external to peer-to-peer network 400 in the native format of the streaming content. For example, client 441 may establish a connection with a replicated streaming source, e.g., streaming source 410 implemented as a peer client, to obtain streaming content in the native format thereof from the replicated streaming source. For example, peer clients configured as replicated streaming sources 410-413 may provide streaming content to external clients in the real time streaming protocol (RTSP), Microsoft Media Services (MMS) protocol, or the like. To this end, streaming sources 410-413 may include a streaming protocol server implemented as a set of computer-executable instructions to facilitate streaming of content to clients external to peer-to-peer network 400. Streaming sources 410-413 may exchange streaming content with one another in a peer-to-peer mode and thus may receive a portion of streaming content from one or more peer clients. Streaming content received by streaming sources 410-413 may be reconstructed by the receiving peer client and saved to a cache or file storage, for example in respective storage devices 450-453.

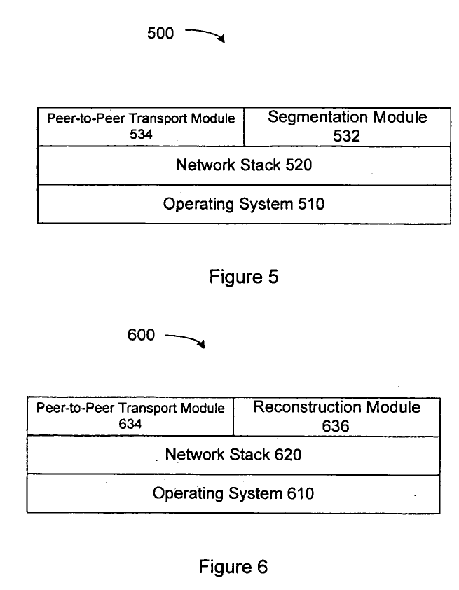

FIG. 5 is a diagrammatic representation of an embodiment of a software configuration 500 for distribution of streaming content in a peer-to-peer network. Software configuration 500 comprises sets of computer-executable instructions or code that may be fetched from a memory and executed by a processing unit of a data processing system. Software configuration 500 is preferably run by a streaming source, such as streaming source 432, from which streaming content is originated in a peer-to-peer network.

Software configuration 500 may include an operating system 510, such as a Windows operating system manufactured by Microsoft Corporation of Redmond, Wash., an OS/2 operating system manufactured by International Business Machines Corporation of Armonk, N.Y., or the like. Operating system 510 may include a network stack 520 for effecting network communications. For example, network stack 520 may be implemented as a transmission control protocol/Internet protocol (TCP/IP) stack. Additionally, software configuration 500 may include a streaming data segmentation module 532 that is adapted to format streaming content in a peer-to-peer transmission format for transmission across a peer-to-peer network by way of peer clients operating in conformity with the peer-to-peer transmission format. For example, segmentation module 532 may segment, concatenate, or otherwise assemble one (or a portion thereof) or more frames of streaming content in the native streaming format thereof, and thereafter encapsulate the segmented frames into a sequence of one or more peer-to-peer transport formatted packets. Segmentation module 532 may interface with storage device 260 or audio/video production equipment 261 shown in FIG. 2 and obtain streaming content in the streaming content native format. Segmentation module 532 then segments the streaming content into a sequence of streaming content data units, such as streaming content data unit 321, and encapsulates each streaming content data unit into a respective peer-to-peer transport packet formatted as described above with reference to FIG. 3.

Software configuration 500 may include a peer-to-peer transport module 534 that comprises logic for self-administration of the peer-to-peer network structure. For example, peer-to-peer transport module 534 may provide self-adjusting functions of the peer client location in the peer-to-peer network topology. Additionally, transport module 534 provides network transmission functions for peer-to-peer transport formatted data streams. For example, transport module 534 may supply peer-to-peer transport formatted packets to network stack 520 for transmission in the peer-to-peer network.

FIG. 6 is a diagrammatic representation of an embodiment of a software configuration 600 that facilitates streaming content replication in a peer-to-peer network. Software configuration 600 comprises sets of computer-executable instructions or code that may be fetched from a memory and executed by a processing unit of a data processing system. Software configuration 600 is preferably run by a replicated streaming source, such as replicated streaming source 410, in a peer-to-peer network for distributing streaming content in a peer-to-peer transport format to other peer nodes and for streaming the streaming content in the native streaming format to clients that are external to the peer-to-peer network.

Software configuration 600 may include an operating system 610. Operating system 610 may include a network stack 620 for effecting network communications. Additionally, software configuration 600 may include a peer-to-peer transport module 634 configured similar to peer-to-peer transport module 534 described above with reference to FIG. 5. Peer-to-peer transport module 634 facilitates receipt and transmission of streaming content encapsulated in a peer-to-peer transport format.

Software configuration 600 may also include a protocol reconstruction module 636 for producing streaming content in the native streaming format from streaming data received in the peer-to-peer transport format. Reconstruction module 636 provides functionality for reorganizing data received from peer-to-peer transport module 634. Reconstruction module 436 facilitates playback of streaming content received in a peer-to-peer transport format. For example, transport module 634 may interface with reconstruction module 636 and pass streaming content encapsulated in a peer-to-peer transport format thereto. Reconstruction module 636 may process the peer-to-peer transport formatted data received from the peer-to-peer transport module 634 and retrieve or otherwise extract streaming content therefrom. Reconstruction module 636 then assembles the extracted streaming content into a streaming content data structure, such as a file or sequence of one or more data blocks, in the native streaming format that may be interpreted by a streaming application adapted for playback of streaming content in the streaming content native format. The streaming content reconstructed in the native streaming format may then be cached or otherwise stored by reconstruction module 636. Reconstruction module provides streaming content server functionality and may pass the streaming content that is reconstructed in the native streaming format to a streaming application adapted for playback of the streaming content in the native streaming content format.

Additionally, protocol reconstruction module 636 is adapted to provide streaming content server functions for streaming the reconstructed streaming content to clients external to the peer-to-peer network, such as one or more of clients 440-446 shown in FIG. 4. In this manner, a replicated streaming source in a peer-to-peer network may function as a streaming content server to clients that are not joined within the peer-to-peer network.

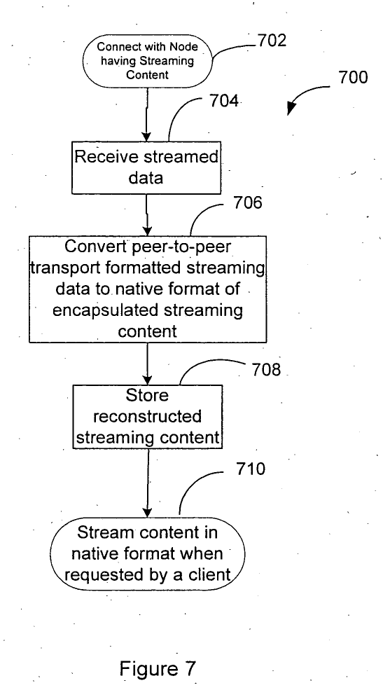

FIG. 7 is a flowchart 700 of an embodiment of processing performed by a peer client for configuration of the peer client as a replicated streaming source in a peer-to-peer network. The peer client connects with one or more peer-to-peer nodes that have streaming content cached or otherwise have access to streaming content (step 702). For example, the client may connect with a streaming source or a peer client that has stored streaming content by selecting one or more nodes from a peer list obtained from the control server. The client receives encapsulated streaming content in the peer-to-peer transport format (step 704), and converts the streamed content into a native format of the streaming content (step 706). For example, the peer client may extract encapsulated streaming content into one or more data blocks formatted according to the peer-to-peer transport format described in FIG. 3. Conversion of the encapsulated streaming content into a native streaming format may be performed, for example, by reconstruction module 636 shown in FIG. 6 after conveyance of the encapsulated streaming content thereto from transport module 634. The reconstructed streaming content may then be stored by the peer client (step 708). The peer client is then configured as a replicated streaming source and may provide streaming content in the native streaming format to clients, such as one or more of clients 440-446 external to peer-to-peer network 400 shown in FIG. 4, in response to receiving a request for the streaming content (step 710).

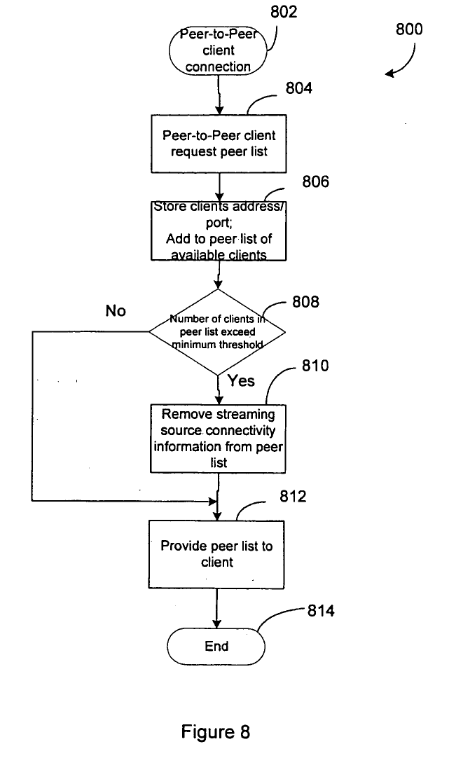

FIG. 8 is a flowchart 800 of an embodiment of processing performed by a control server in a peer-to-peer network for facilitating delivery of streaming content in a peer-to-peer network. A client connects with the control server (step 802) and submits a request for a list of peers (step 804). The control server adds connectivity information, such as an IP address and port number, of the client to a peer list that contains connectivity information of peer-to-peer clients with which other peer clients may connect (step 806). The peer list maintained by the control server may initially include only connectivity information of streaming source 232, and control server 231 adds connectivity information of peer clients as clients join the peer-to-peer network.

The control server may evaluate the number of clients having connectivity information included in the peer list to determine if the number of clients in the peer-to-peer network equals or exceeds a pre-defined threshold (step 808). The threshold defines a minimum number of clients that are to be included in the peer-to-peer network prior to the control server removing connectivity information of the streaming source from the peer list. In this manner, the connectivity information of the streaming source is distributed with the connectivity information of peer clients until the peer-to-peer network includes a sufficient number (as defined by the threshold) of clients to provide for the streaming content without additional distribution of the streaming source's connectivity information. In the event the number of clients in the peer list equals or exceeds the threshold, the control server removes connectivity information of the streaming source from the peer list (step 810), and then conveys the peer list to the requesting client (step 812). In the event that the control server determines the number of clients in the peer list does not equal or exceed the threshold at step 808, the control server proceeds to convey the peer list (including connectivity information of the streaming source) to the requesting client according to step 812. Control server processing then ends according to step 814. In this manner, clients joining the peer-to-peer network are provided connectivity information of the streaming source until the peer-to-peer network has grown to a sufficient size in which the connectivity information of the streaming source may no longer be distributed to newly joining clients. Thus, the load on the streaming source may be reduced when the peer-to-peer network has grown to a size that equals or exceeds the threshold.

As described, embodiments provide mechanisms for replicating streaming content in a peer-to-peer network. Clients may access streaming content provided by a streaming source by way of a connection with the streaming source or a replicated source implemented as a peer client. A peer client receives streaming content encapsulated in one or more packets or data blocks formatted according to a transport format of the peer-to-peer network. The peer client extracts the streaming content from the one or more data blocks and reconstructs the streaming content in a native format of the streaming content. For example, the peer client may assemble the streaming content into a native format of the streaming content by concatenating extracted streaming content data units together. The client then stores the streaming content in the native format and may convey the streaming content in the native format to a client that is external to the peer-to-peer network.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of replicating streaming content in a peer-to-peer network, comprising:
receiving, by a first client of the peer-to-peer network, streaming content encapsulated in one or more data blocks formatted according to a transport format of the peer-to-peer network;
extracting the streaming content from the one or more data blocks;
assembling the streaming content into a native format of the streaming content;
storing the streaming content in the native format; and
conveying at least a portion of the streaming content in the native format to a second client external to the peer-to-peer network.

2. The method of claim 1, further comprising receiving, by the first client, a peer list of connectivity information of one or more nodes in the peer-to-peer network, wherein the streaming content is received from at least one of the one or more nodes.

3. The method of claim 2, wherein receiving the peer list further comprises receiving the peer list that includes connectivity information of a streaming source that originated the streaming content.

4. The method of claim 2, further comprising:
generating the peer list including connectivity information of a streaming source that originated the streaming content; and
evaluating a number of clients in the peer-to-peer network in response to receiving a request for the peer list.

5. The method of claim 4, further comprising removing the connectivity information of the streaming source if the number of clients equals or exceeds a threshold.

6. The method of claim 1, further comprising transmitting the streaming content encapsulated in the one or more data blocks to a second client of the peer-to-peer network.

7. The method of claim 6, further comprising:
storing, by the second client of the peer-to-peer network, the streaming content encapsulated in the one or more data blocks;
extracting, by the second client of the peer-to-peer network, the streaming content from the one or more data blocks;
assembling, by the second client of the peer-to-peer network, the streaming content into the native format of the streaming content;
storing, by the second client of the peer-to-peer network, the streaming content in the native format.

8. The method of claim 1, further comprising:
establishing a connection with a client external to the peer-to-peer network; and
conveying the streaming content in the native format to the client external to the peer-to-peer network.

9. A computer-readable medium having computer-executable instructions for execution by a processing system, the computer-executable instructions for replicating streaming content in a peer-to-peer network, comprising:
instructions that receive encapsulated streaming content in one or more data blocks formatted according to a transport format of the peer-to-peer network;
instructions that extract the streaming content from the one or more data blocks;
instructions that assemble the streaming content into a native format of the streaming content;
instructions that store the streaming content in the native format; and
instructions that convey at least a portion of the streaming content in the native format to a second client external to the peer-to-peer network.

10. The computer-readable medium of claim 9, further comprising instructions that receive a peer list of connectivity information of one or more nodes in the peer-to-peer network, wherein the streaming content is received from at least one of the one or more nodes.

11. The computer-readable medium of claim 10, wherein the peer list includes connectivity information of a streaming source that originated the streaming content.

12. The computer-readable medium of claim 10, further comprising:
instructions that generate the peer list including connectivity information of a streaming source that originated the streaming content; and
instructions that evaluate a number of clients in the peer-to-peer network in response to receiving a request for the peer list.

13. The computer-readable medium of claim 12, further comprising instructions that remove the connectivity information of the streaming source if the number of clients equals or exceeds a threshold.

14. The computer-readable medium of claim 9, further comprising instructions that transmit the encapsulated streaming content in the one or more data blocks to a second client of the peer-to-peer network.

15. The computer-readable medium of claim 14, further comprising:
instructions executed by the second client of the peer-to-peer network that store the encapsulated streaming content in the one or more data blocks;
instructions executed by the second client of the peer-to-peer network that extract the streaming content from the one or more data blocks;
instructions executed by the second client of the peer-to-peer network that assemble the streaming content into the native format of the streaming content;
instructions executed by the second client of the peer-to-peer network that store the streaming content in the native format.

16. The computer-readable medium of claim 9, further comprising:
instructions that establish a connection with a client external to the peer-to-peer network; and
instructions that convey the streaming content in the native format to the client external to the peer-to-peer network.

17. A data processing system for replicating streaming content in a peer-to-peer network, comprising:
a memory that contains a transport module and a reconstruction module as sets of instructions;
a network adapter that interfaces with a communications medium; and
a processing unit that, responsive to execution of one or more of the sets of instructions, receives encapsulated streaming content formatted according to a transport format of the peer-to-peer network over the communications medium, reconstructs the streaming content in a native streaming format, and that conveys the streaming content in the native streaming format to a client that is external to the peer-to-peer network.

18. The system of claim 17, wherein the processing unit reconstructs the streaming content by extracting the streaming content from the encapsulated streaming content and assembling the streaming content into a data structure compliant with the native format.

19. The system of claim 18, wherein the processing unit stores the data structure.

20. The system of claim 18, wherein the processing unit stores the encapsulated streaming content.

21. The system of claim 17, wherein the processing unit receives a peer list of connectivity information of one or more nodes in the peer-to-peer network, and wherein the encapsulated streaming content is received from at least one of the one or more nodes.

22. The system of claim 17, wherein the processing unit establishes a connection over the communication medium with a client in the peer-to-peer network and conveys at least a portion of the encapsulated streaming content to the client.

23. The system of claim 17, wherein the processing unit establishes a connection with a client external to the peer-to-peer network and conveys the streaming content in the native streaming format to the client external to the peer-to-peer network.
